(19) United States
(12) Patent Application Publication
(10) Pub. No.: US 2019/0013828 A1
(43) Pub. Date: Jan. 10, 2019

(54) METHOD AND SYSTEM FOR IMPROVING SPURIOUS FREE DYNAMIC RANGE OF SIGNAL PROCESSING SYSTEMS

(71) Applicant: CSIR, Pretoria (ZA)

(72) Inventor: Marcel GOUWS, Pretoria (ZA)

(73) Assignee: CSIR, Pretoria (ZA)

(21) Appl. No.: 15/752,433

(22) PCT Filed: Aug. 12, 2016
(86) PCT No.: PCT/IB2016/054861

§ 371 Date: Feb. 13, 2018

(30) Foreign Application Priority Data
Aug. 14, 2015 (ZA) 2015/05892

(51) Int. Cl. H04B 1/00; H04B 1/04; H04B 1/12; H04B 1/16

(52) U.S. Cl. CPC H04B 1/0017; H04B 1/16; H04B 1/126; H04B 1/0475

(57) ABSTRACT

This invention relates to a system and method for processing signals in a signal processing system so as at least to ameliorate spurious signals generated in said signal processing system during processing of signals. The method, which is implemented by the system in accordance with the invention, typically comprises receiving a signal of unknown and arbitrary frequency within the operating frequency range of the signal processing system, wherein the input signal comprises at least a fundamental signal. The method then comprises generating, in one signal processing path, a compensation signal with same amplitude and phase as the spurious signal. The compensation signal is then subtracted from the received input signal or added out of phase to the received input signal, in another signal processing path. In this way, the spurious signal is cancelled from the received signal and/or the received signal is pre-distorted to account for spurious signals generated during further processing in the signal processing system.

### FIELD OF THE INVENTION

This invention relates to a system and method for improving spurious free dynamic range (SFDR) of systems, particularly to a system and method for reducing spurious signals in digital and radio frequency circuitry by use of digital signal processing so as to improve the spurious free dynamic range (SFDR) of systems.

### BACKGROUND OF THE INVENTION

Spurious signals in the form of undesired intermodulation (mixing) products are a widespread problem in RF signal processing and results in reduced system performance. Analogue-to-digital converters (ADCs) and digital-to-analogue converters (DACs) are nonlinear devices that produce in-band intermodulation products that reduce the system SFDR.

Using wider bandwidth converters usually comes with the trade-off of significantly reduced SFDR, which limits the performance and applications possible with wideband ADC and DAC devices. The increasing trend towards wider bandwidths makes this an important problem to address. RF modulation circuitry such as mixers and amplifiers also generate undesired mixing products in addition to the desired outputs, since they are also inherently non-linear.

Some conventional systems often address the problem of unwanted signals by making use of adaptive filters which adaptively provide suppression of undesired signals based on a real-time estimation of the same. However, these adaptive filters are not ideal for use in environments where time and frequency overlapping signals occur as their operation may be corrupted by such overlapping signals. This problem is exacerbated in environments where signals are brief in that adaptive filters take time to converge to an optimal filter response, which requires the signals to be present for a minimum amount of time to achieve the same.

It is that an object of the present invention to address the abovementioned problems.

### SUMMARY OF THE INVENTION

According to a first aspect of the invention, there is provided a method for processing a signal in a signal processing system, wherein the method comprises:

receiving a signal of unknown and arbitrary frequency within the operating frequency range of the signal processing system or apparatus, wherein the received signal comprises a fundamental signal;

simultaneously digitally processing the received signal in at least two parallel signal processing paths, a first signal processing path and a second signal processing path, respectively;

generating, in the second signal processing path, a compensation signal by filtering the received signal with a non-adaptive time-invariant phase and amplitude adjustment filter associated with a characterised spurious signal generated in the signal processing system in processing a signal, and processing the filtered signal to correspond substantially to the frequency of the spurious signal, wherein the compensation signal is a replica of the spurious signal; and

subtracting the generated compensation signal from the received signal, or adding the generated compensation signal out of phase to the received signal, in the first signal processing path so as to cancel the spurious signal generated in the processing system thereby yielding a compensated signal.

It will be appreciated that the signals processed in the first and second processing paths are identical prior to the processing of these signals in these respective paths. To this end, the method may comprise replicating the received signal in the first and second signal processing paths.

In one example embodiment, the signal processing system may be a distributed system such as geographically distributed system. However, in some example embodiments, the system may be embodied in an apparatus, as the case may be.

The use of the non-adaptive time-invariant filter may allow the method and system as described herein to operate in environment where time and frequency overlapping signals occur, since operation is not dependent on real-time estimation of an unwanted signal which may be corrupted by other overlapping signals. Moreover, as adaptive filters take time to converge to an optimal filter response and require that desired signals must be present for a minimum amount of time, the method and system as described herein may be used in environments where signals may be brief, typically where there would not be sufficient time for adaptive filters to converge and provide good distortion suppression.

The fundamental signal or fundamental signal component is typically a desired component of the received signal whereas the spurious signal or at least one spurious signal is an undesired component thereof.

It will be noted that the system's operating frequency range need not be larger than the possible frequency range of the input or received signal in order for the compensated signal to be generated without the at least one spurious signal therein. Thus there is no need for additional filters to isolate received signals to a smaller bandwidth within a much wider sampling bandwidth. In this regard, no a priori information regarding the received or input signal is required, which makes the method and system as described herein well suited to environments where there is no prior knowledge of the signal that will be received by the signal processing system.

The method may comprise a prior step of characterising spurious signals to be cancelled and generating a wideband FIR (Finite Impulse Response) phase and amplitude adjustment filter based thereon. This may be achieved by:

determining a frequency relationship between at least one spurious signal generated by the processing of a signal by the processing system and a fundamental signal associated with the said signal processed by the processing system;

determining an amplitude and phase relationship between the at least one spurious signal and the fundamental signal;

generating the non-adaptive time-invariant phase and amplitude adjustment filter in the form of a wideband FIR (Finite Impulse Response) phase and amplitude adjustment filter by using the determined amplitude and phase relationship, wherein filtering a received signal with the generated phase and amplitude adjustment filter scales same to approximately the same amplitude and phase as the at least one spurious signal.

The method may comprise:

generating the compensation signal by:
filtering the received signal in the second signal processing path using the generated phase and amplitude adjustment filter; and
processing the filtered signal with information indicative of the determined frequency relationship between at least one spurious signal and the fundamental signal such that the processed signal corresponds substantially to the frequency of the spurious signal.

It will be appreciated that the processed signal is the compensation signal used above in the subtraction/adding step.

The method may comprise filtering the received signal in the second signal processing path with the phase and adjustment filter to generate a real-valued filtered signal of substantially the same amplitude and phase as the at least one spurious signal.

Processing the filtered signal with information indicative of the determined frequency relationship between the at least one spurious signal and the fundamental signal may comprise:

converting the filtered signal to a complex-valued signal;

if a negative frequency image of the filtered signal is required, then obtaining a conjugate of the complex-valued signal;

multiplying, in the time-domain, the complex-valued signal with a complex exponential signal with unitary amplitude and a predetermined offset frequency associated with the at least one spurious signal; and

converting the product of the multiplication step to a real-valued format for use as the compensation signal for the subtracting/adding step.

The signal in the first processing path may be delayed by a delay equivalent to a processing delay in the second signal processing path.

The method may comprise receiving the signal from an ADC (Analogue to Digital Converter), or streaming the signal from a memory device. In addition, the method may comprise pre-distorting an output to a DAC (Digital to Analogue Converter), memory device, or processor with the compensation signal.

Determining a frequency relationship between the at least one spurious signal and a fundamental signal of a signal processed by or in the processing system may comprise:

applying a continuous wave as an input signal to the processing system;

measuring a resultant signal at a predetermined point in the processing system after generation of the spurious signal; and

measuring or determining a mathematical relationship between the frequency of the spurious signal and the frequency of the fundamental signal.

Determining an amplitude and phase relationship between the at least one spurious signal and the fundamental signal may comprise:

applying a continuous wave as an input signal to the processing system for a range of distinct frequencies such that the frequency of a fundamental signal is equally spaced across a Nyquist bandwidth of an ADC (Analogue to Digital Converter) associated with the processing system;

at a predetermined point in the processing system after generation of the spurious signal, determining a ratio between complex amplitudes of the spurious signal and fundamental signal from measurements taken at the predetermined point;

optionally correcting the complex amplitude ratio, for a measured or previously determined measurement error, by a distortion factor in the processing system; and

designing or generating a FIR (Finite Impulse Response) phase and amplitude adjustment filter to approximate the amplitude and phase response of the corrected complex amplitude ratio.

After cancelling the spurious signal, the method may comprise scaling the compensated signal by applying a gain.

The method may comprise generating a compensation signal to cancel a plurality of spurious signals from the input signal. The method may be a computer implemented method.

According to a second aspect of the invention there is provided a system for processing a signal in a signal processing system or apparatus, wherein the system comprises:

a processor comprising:

a receiver module operable to receive a signal of unknown and arbitrary frequency within the operating frequency range of the signal processing system, wherein the received signal comprises at least a desired signal component or fundamental signal, and wherein the processor is configured to simultaneously digitally process the received signal in at least two parallel signal processing paths, a first signal processing path and a second signal processing path, respectively;

a spurious signal synthesis module located in the second signal processing path, wherein the spurious signal synthesis module is configured to generate a compensation signal by filtering using the received signal with a non-adaptive time-invariant phase and amplitude adjustment filter associated with a characterised spurious signal generated in the signal processing system in processing a signal, and processing the filtered signal to correspond substantially to the frequency of the spurious signal, wherein the compensation signal is a replica of the spurious signal; and

a summing module operable to subtract the generated compensation signal from the received signal, or add the generated compensation signal out of phase to the received signal, in the first signal processing path so as to cancel the at least one undesired spurious signal generated in the signal processing system thereby yielding a compensated signal.

The input received by the receiver module may be received from an ADC (Analogue to Digital Converter) operatively coupled to the receiver module for sampling RF (Radio Frequency) signals, or read from a memory device.

The system may be operable to output the compensated signal to a DAC (Digital to Analogue Converter), memory device, or processor.

The filter may be based on the prior characterisation of spurious signals in the signal processing system or apparatus.

The spurious signal synthesis module may comprise the non-adaptive time-invariant phase and amplitude adjustment filter in the form of a wideband FIR (Finite Impulse Response) filter comprising parameters based on prior spurious signal characterisation of the signal processing system or apparatus. The filter may be configured to filter the received signal in the second signal processing path to generate a real-valued filtered signal of substantially the same amplitude and phase as the at least one spurious signal. As mentioned above, this filtered signal may be further processed by the spurious signal synthesis module to provide a processed signal of substantially the same frequency as the spurious signal.

The synthesis module may further comprise:

a quadrature generation module to convert the scaled/filtered signal to a complex-valued signal, wherein if a negative frequency image of the scaled/filtered signal is required, then the spurious signal synthesis is configured to obtain a conjugate of the complex-valued signal;

a multiplier operable to multiply, in the time-domain, the complex-valued signal with a complex exponential signal with unitary amplitude and a predetermined offset frequency associated with the at least one spurious signal; and

a real-value converter operable to convert the product of the multiplier to a real-valued format compensation signal.

The processor may comprise a delay module configured to apply a delay to the received signal in the first processing path, wherein the delay is selected to be equivalent to a processing delay in the second signal processing path.

The system comprises a memory device.

The processor may comprise a gain module operable to scale the compensated signal by applying a gain after cancelling the spurious signal.

The system may comprise an ADC (Analogue to Digital Converter) operatively coupled to the receiver module for sampling RF (Radio Frequency) signals.

The system may comprises RF (Radio Frequency) circuitry suitable for receiving and transmitting RF signals.

The system may be integrated into the signal processing system.

According to a third aspect of the invention, there is provided an apparatus or device for processing a signal in a signal processing system or apparatus, wherein the apparatus or device comprises:

a processor comprising:
a receiver module operable to receive a signal of unknown frequency, wherein the received signal comprises at least a desired signal component or fundamental signal, and wherein the processor is configured to simultaneously process the received signal in at least two parallel signal processing paths, a first signal processing path and a second signal processing path, respectively;
a spurious signal synthesis module located in the second signal processing path, wherein the spurious signal synthesis module is configured to generate a compensation signal using the received signal, and wherein the compensation signal is a replica of at least one undesired spurious signal generated in the processing system in processing the received signal; and
a summing module operable to subtract the generated compensation signal from the received signal, or add the generated compensation signal out of phase to the received signal, in the first signal processing path so as to cancel the at least one undesired spurious signal generated in the signal processing system, in use, so as to yield a compensated signal.

It will be appreciated that the processor of the apparatus/device may be substantially similar to that of the system described above and thus the modules described with reference thereto apply equally herein.

### BRIEF DESCRIPTION OF THE DRAWINGS

FIG. 1 shows a high level block diagram of a system in accordance with an example embodiment of the invention;

FIG. 2 shows a high level flow diagram of a method in accordance with an example embodiment of the invention;

FIG. 3 shows a high level block diagram of a system and/or process flow in accordance with an example embodiment of the invention;

FIG. 4 shows another high level block diagram of a system and/or process flow in accordance with an example embodiment of the invention;

FIG. 5 shows another flow diagram of a method in accordance with an example embodiment of the invention;

FIG. 6 shows a block diagram of a system and/or process flow in accordance with an example embodiment of the invention; and

FIG. 7 shows yet another high level block diagram of a system and/or process flow in accordance with an example embodiment of the invention.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

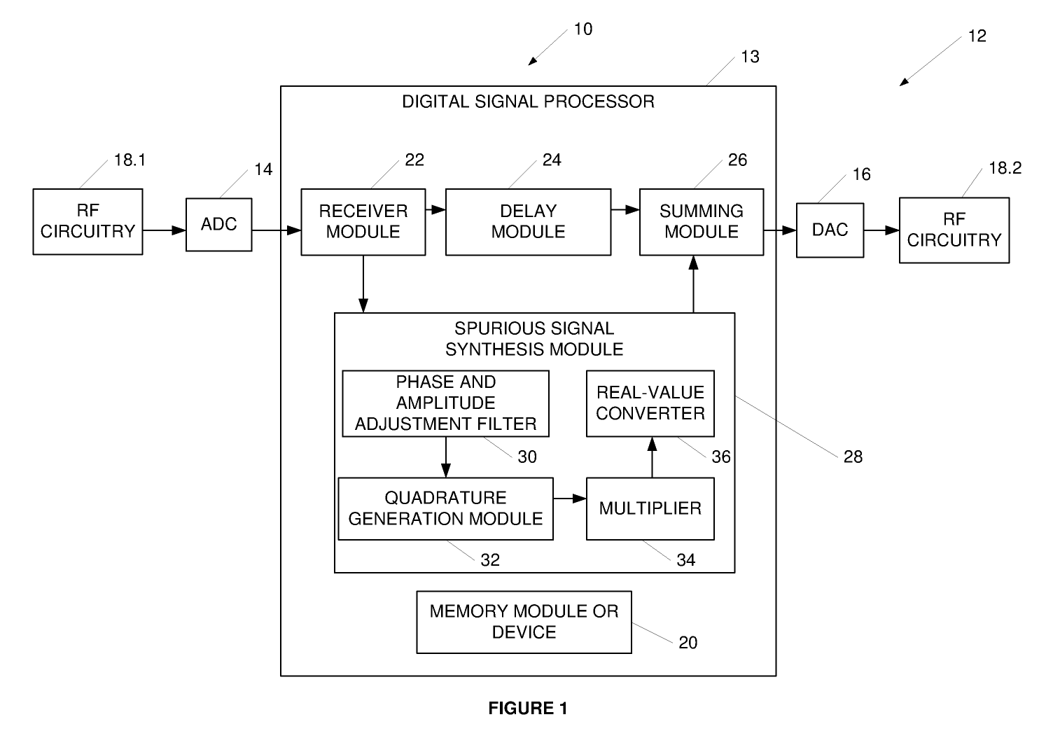

Although reference will be made to the FIGS. 1 to 7 in general, it will be appreciated that attention may be drawn to one or more Figure/s, as the case may be, in particular to facilitate better understanding of the invention described herein.

Furthermore, it should be pointed out that the same parts described in the different embodiments are denoted by the same reference numbers and the same component names and the disclosures made throughout the description can be transposed in terms of meaning to same parts bearing the same reference numbers or same component names.

Referring to FIG. 1 of the drawings, a system, arrangement or apparatus in accordance with an example embodiment of the invention is generally indicated by reference numeral 10. The system 10 may typically be provided in a processing system 12 comprising or in communication with digital and/or radio frequency (RF) circuits, etc. As will be described below, the system 10 is typically configured to reduce spurious signals in the processing system 12, the latter processing signals received thereby.

The system 10 comprises a processor 13 in operative communication with an ADC (Analogue to Digital Converter) 14 and DAC (Digital to Analogue Converter) 16 which in turn are operatively coupled to RF circuitry 18.1, 18.2 forming part of the processing system 12. The processing system 12 may be configured to receive and/or transmit and/or process RF signals, in use. It will be appreciated that in some example, embodiments, the system 10 may only comprise the processor 13 and optionally its associated components and/or circuitry. However, in some example embodiment, the system 10 may additionally comprise the ADC 14 and/or DAC 16, or even the RF circuitry 18.1, 18.2 as the case may be.

The processor 13 is typically a digital signal processor or field-programmable gate array (FPGA) comprising a plurality of components or modules which correspond to the functional tasks to be performed by the processor 13 and thus the system 10. In this regard, “module” in the context of the specification will be understood to include an identifiable portion of code, computational or executable instructions, data, or computational object to achieve a particular function, operation, processing, or procedure. It follows that in other example embodiments, a module need not be implemented in software; a module may be implemented in software (including firmware), hardware, or a combination of software and hardware. Further, the modules need not necessarily be consolidated into one device but may be spread across a plurality of devices.

The system 10 may also include a machine-readable medium, e.g. memory module/device 20 in the processor 13, main memory, and/or hard disk drive, which carries a set of non-transitory instructions which when executed direct the operation of the processor 13 and essentially provides the modules described herein. It is to be understood that in some example embodiments, the processor 13 may be one or more microprocessors, controllers, or any other suitable computing device, resource, hardware, software, or embedded logic/firmware. In addition to processing signals and/or data as described herein, it will be appreciated that the processor 13 may be operable to perform other processing activities as determined by the requirements of processing system 12.

The processor 13 is typically configured to process RF signals sampled by the ADC 14. To this end, it will be noted that the signals sampled by the ADC 14 from the RF circuitry 18, and/or processed in the system 12 are typically continuous wave (CW) input signals of frequency co and with form A(ω)cos(ωt). However, when acted upon by nonlinear components (e.g., the ADC 14, DAC 16, RF circuitry 18.1, 18.2 in the processing system 12), undesired spurious signals in the form of intermodulation signals are produced. For the continuous wave input signal described above, the intermodulation signal is typically of form:

xₛₚᵤᵣ(t)=B(ωₛ)cos(ωₛt+φ(wₛ)) (1)

The frequency ωₛ of the intermodulation signal generated in (1) is related to the input frequency by ωₛ=kω+ω_{offset}, where ω_{offset} represents an offset frequency resulting from intermodulation. In general, k may take any integer value; however the present disclosure specifically addresses intermodulation products with the fundamental input signal itself and not its higher order harmonics. For the purpose of this invention description, k may hence take the value k=±1. It follows that the term “spurious signal” as used in this description refers to intermodulation products. For the purpose of this invention description the term “fundamental signal” refers to a signal having the same frequency as the main input signal (for example, to the ADC 14 and/or DAC 16 and/or RF circuitry 18.1, 18.2), which is the frequency within the intermodulation distortion process that results in the spurious component in Equation (1). The term “fundamental signal” consequently implies a relation between the frequency of said signal and a generated spurious signal according to the equation ωₛ=kω+ω_{offset}, with co representing the frequency of the fundamental signal and ωₛ the frequency of a spurious signal. Differently defined, the fundamental signal component may be considered a desired component of a signal processed in the system 12 and the spurious signal may be considered to be an undesired signal component generated by non-linear components in the processing system 12. In any event, it will be appreciated that for brevity, term “fundamental frequency”, “fundamental component”, “desired signal component”, and “desired component” will all be understood to refer to the same “fundamental frequency” as described herein, as the case may be.

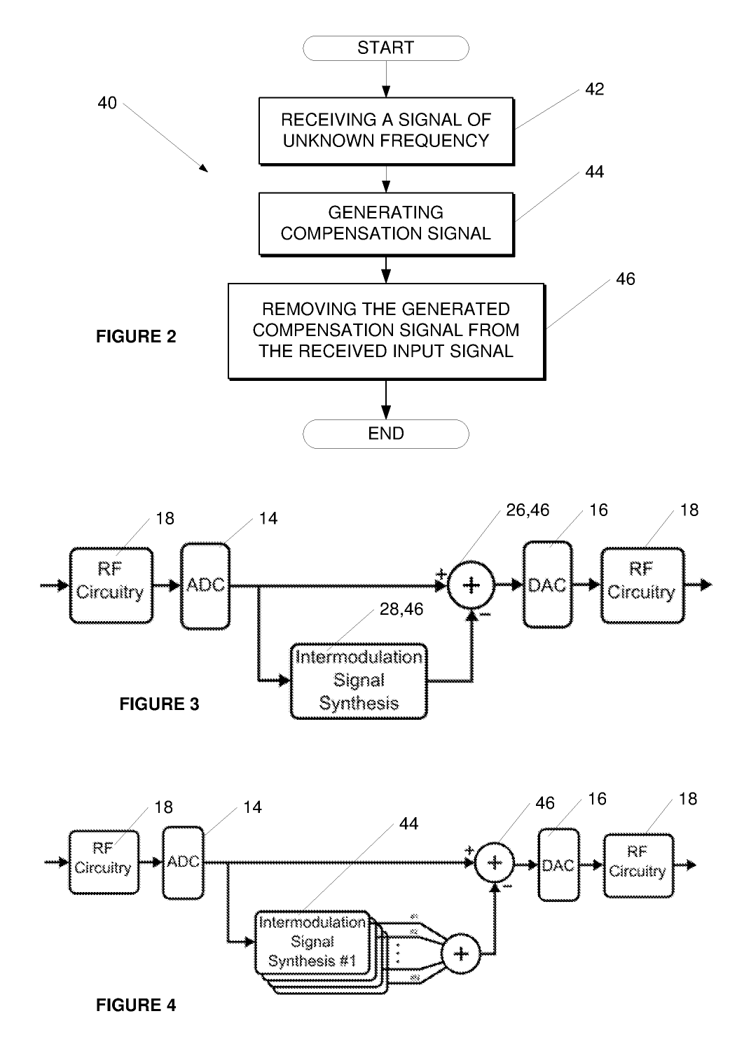

In any event, as mentioned above, the system 10 typically serves to reduce the spurious signals generated by non-linear components within the processing system 12 digitally in real-time, or substantially in real-time, by way of digital signal processing with the processor 13 thereby to improve the spurious-free dynamic range (SFDR) of the processing system 12. Though described with reference to the processing system 12 containing the ADC 14 to sample analogue RF signals received by the RF circuitry 18.1, and a DAC 16 to convert digital signals back to analogue and back to RF signals via RF circuitry 18.2, the system 10 as described herein may also be used in a processing system (not illustrated) having a configuration where the ADC 14 is absent, for example wherein the signal to be processed in said processing system is read from memory storage (e.g., memory 20) instead of being sampled by an ADC 14. Similarly, the system 10 as herein described may also be used in a processing system (not shown) where the DAC 16 is absent, for example when the system is a digital receiver that only samples data. The processor 13 typically comprises a receiver module 22, a delay module 24, a summing module 26, and a spurious signal synthesis module 28. The spurious signal synthesis module 28 comprises a plurality of sub-modules/components corresponding to the functional tasks which the module 28 is to perform. In particular, the module 28 comprises a phase and amplitude adjustment filter 30, a quadrature generation module 32, a multiplier, 34 and a real-value converter 36. Operation of these modules will be further described with reference to FIGS. 2 to 7.

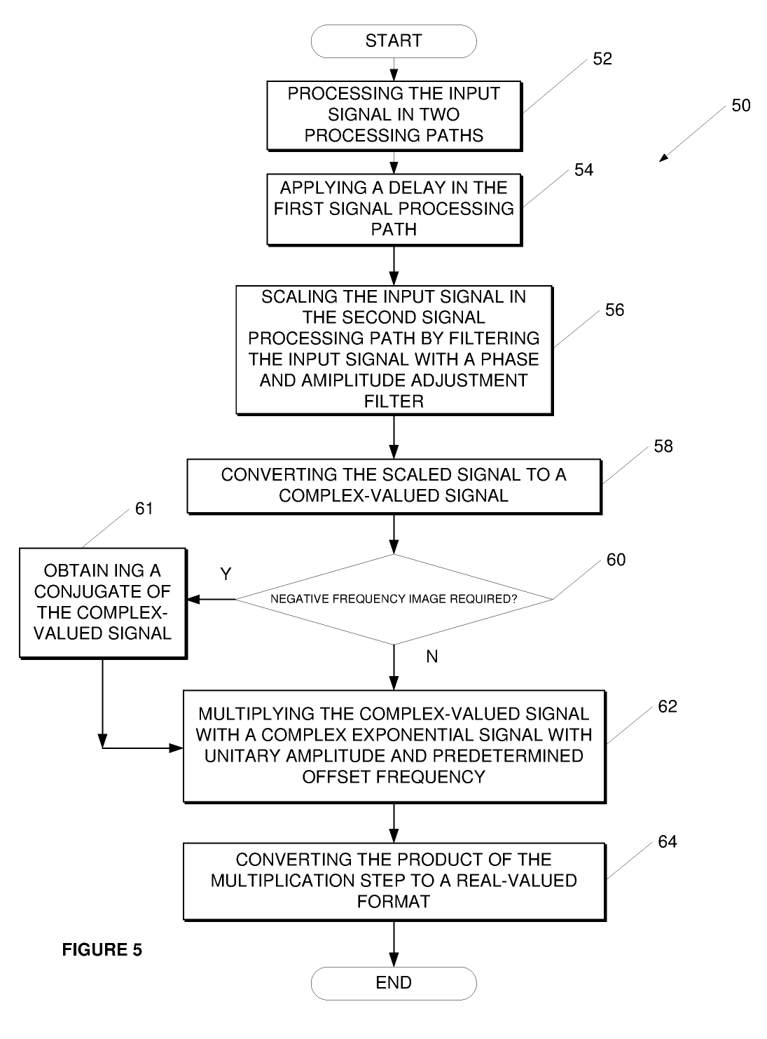

Referring now also to FIGS. 2 to 7 of the drawings, wherein the example methods shown in FIGS. 2 and 5 are described with reference to FIG. 1 as well as the system and/or process flow block diagrams illustrated in FIGS. 3, 4 and 6, 7 respectively. It is to be appreciated that example methods described herein may be applicable to other systems and/or processes (not illustrated) as well. For completeness, similar method/process steps described and/or illustrated herein may be referenced in the drawings with the same reference numerals.

Referring to FIG. 2 of the drawings, a flow diagram of a method in accordance with an example embodiment is generally indicated by reference numeral 40. The method 40 comprises receiving a signal of unknown frequency at block 42 by way of the receiver module 22 which is, in the illustrated example embodiment, communicatively coupled to the ADC 14. To this end, it will be noted that the ADC 14 may typically sample an input signal to the RF circuitry 18.1 and pass said sampled signal to the receiver module 22 for processing by the processor 13. In some example embodiments (not shown), the signal may be read from memory or a data storage means or medium.

The received signal typically comprises a desired signal component or fundamental signal and an undesirable signal component or spurious signal or in other words, an intermodulation product, for example, generated by the ADC 14 and/or RF circuitry 18.1. However, in the case of compensation for an intermodulation product introduced by the DAC 16 and/or RF circuitry 18.2, the undesirable signal component is yet to be added to the received/processed signal.

The method 40 then comprises the step of generating, at block 44, a compensation signal with the synthesis module 28, wherein the compensation signal is essentially a replica of the spurious signal/intermodulation product, for example, with respect to its frequency, amplitude, and phase generated by the non-linear component/s in the processing system 12.

The method 40 then comprises subtracting, at block 46, the generated compensation signal from the received signal, via the summing module 26. Differently defined, the method 40 adds the generated compensation signal out of phase with the received signal so as to cancel the intermodulation product already added by the non-linear components of the processing system 12 (for example, by the ADC 14) or yet to be added by the non-linear components of the processing system 12 (for example, the DAC 16). In this way spurious signals are reduced in processing signals in the processing system 12.

The method 40 processes data sampled by the ADC 14 in a real-time, streaming fashion to reduce spurious components and the processed signal is converted back to analogue by the DAC 16 at the same or substantially the same data rate. To this end, the method 40 comprises generating the compensation signal is a real-time, streaming fashion by way of the module 28 and subtracting same from the received signal also in a real-time fashion.

In the example embodiment illustrated in FIG. 1 (i.e., the system 10 comprising an ADC 14, signal processor 13 and DAC 16), the system 10 is operable to remove intermodulation signals that appear within its instantaneous bandwidth (IBW), namely the Nyquist frequency band of the ADC 14 and DAC 16.

As illustrated in FIG. 4, the method as described herein may also address several spurious components at once, by generating/synthesizing several respective compensation signals which are all added back to the input signal out of phase as described above.

Though not illustrated, it will be appreciated that the method 40 may comprise an initial or prior step of characterising the undesired intermodulation signal components in the system with regards to their frequency, amplitude and phase relationship with an input CW signal. Following notation from Equation (1), this involves measuring the amplitude response B(ωₛ) and phase response φ(ωₛ) of the intermodulation signal across the bandwidth of interest.

In particular, in characterising the intermodulation signal, the parameters of the undesired intermodulation signal must be deduced, and its amplitude and phase relationship relative to the first-order, fundamental input signal must be measured across the ADC 14 and/or DAC 16 Nyquist frequency band.

In any event, the step of intermodulation signal characterisation proceeds as follows:
1. The frequency relationship between the undesired intermodulation signal and the fundamental signal is determined by measurement:
   a. A signal A(ω)cos(ωt) is applied at the input of the system 10, which leads to generation of the intermodulation component B(ωₛ)cos(ωₛt+φ(ωₛ)), with ωₛ=kω+ω_{offset} and k=±1. A measurement point is chosen at a point in the system 10 after generation of the intermodulation product and the signal spectrum at the measurement point is measured, for example using a spectrum analyser.
   b. The input frequency co is increased. The parameter k is positive if the frequency of the intermodulation product ωₛ increases with increase of the input frequency, otherwise it is negative. Thus it will be noted that this step is utilised merely to obtain an indication of whether k is −1 or +1.
   c. The offset frequency ω_{offset} is accurately measured using a spectrum analyser, or deduced through knowledge of the signal or process that generates the intermodulation product.
2. The amplitude and phase relationship between the intermodulation signal and the fundamental is determined as follows:
   a. A signal is applied at the input of the system 10 for a range of N+1 distinct frequencies, chosen such that the frequency of the fundamental signal at the ADC 14 input will be equally spaced across the ADC's Nyquist bandwidth. The applied input signal hence results in a signal at the ADC 14 input with frequency

$${ω}_{i} = i \frac{{F}_{s}}{2 N}$$

for i=0 to N, where Fₛ is the sampling rate of the ADC 14.
b. A signal measurement point is chosen at a point in the system 10 after generation of the intermodulation product. The measurement point may be in the analog or digital domain, but not within the intermodulation signal synthesis branch shown in FIGS. 3 & 4.
c. For each frequency ωᵢ, the ratio Rₘₚ(ωᵢ) between the complex amplitudes of the intermodulation product and the fundamental signal is determined from measurements at the measurement point.
d. In some instances an additional linear amplitude and phase distortion occurs in the system 10 in between the measurement point and the synthesis module 28, e.g. the amplitude slope of the DAC 16. This distortion represents an error in measurement of the ratio Rₘₚ(ωᵢ) and must be characterised and removed. For each frequency ωᵢ, the complex amplitude factor added by the distortion, Rₑᵣᵣ(ωᵢ) is determined through measurement. If no error is present, Rₑᵣᵣ(ωᵢ)=1 for all frequencies.
e. The corrected complex amplitude ratio between the intermodulation and fundamental signal is calculated for each frequency: Rᵢₘ(ωᵢ)=Rₘₚ(ωᵢ)/Rₑᵣᵣ(ωᵢ).
3. The ratio Rᵢₘ(ωᵢ) represents the complex amplitude by which the received signal must be scaled in order to have the same amplitude and phase as the undesired intermodulation signal. A FIR (Finite Impulse Response) phase and amplitude adjustment filter 30 is generated or designed to approximate the amplitude and phase response represented by Rᵢₘ(ωᵢ). It will be noted that the filter 30 is thus a wideband FIR filter based upon spurious values pre-characterised or characterised in a prior step.

Referring to FIG. 5 of the drawings, where another flow diagram of a method in accordance with an example embodiment is generally indicated by reference numeral 50. It will be appreciated that the method 50 may typically be a more detailed description of some of the method steps, particularly the steps 44 of the previous Figures. In particular, it will be appreciated that the method 50 proceeds after receiving, by way of the module 22, digital data of an input signal from the RF circuitry sampled by the ADC 14. The module 22 may be configured to receive multiple concurrent input signals at different frequencies that may overlap in time, frequency modulated signals, and the like. It will be noted that the frequency of the input signal(s) need not be known and may occur anywhere within the processing system 12 Nyquist band.

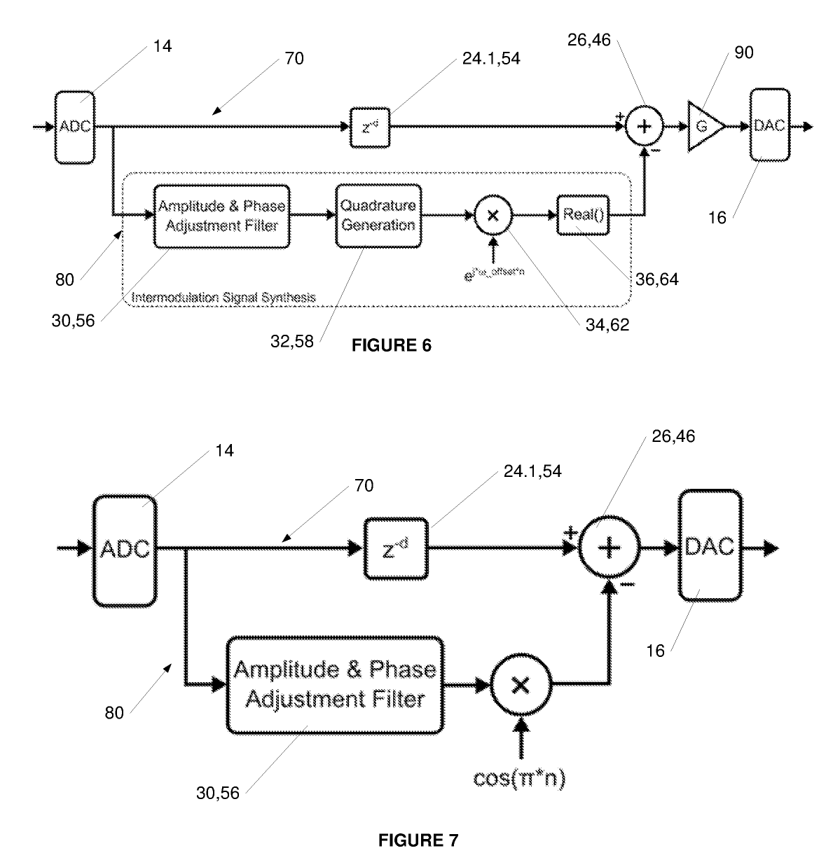

The method 50 comprises processing, at block 52, the received signal in two processing paths, viz., a first and second digital signal processing paths 70, 80 (see FIGS. 6 & 7). To this end, the method 50 comprises replicating the received signal in the two processing paths.

The first signal processing path 70 contains the unmodified input signal, to which a compensation signal containing a synthesized intermodulation signal will be added (out of phase). The second signal processing path 80 is processed to synthesize the compensation signal that will be added to the original, in order to cancel the undesired intermodulation components (in a manner that will be described below).

In any event, the method 50 comprises applying a delay 24.1, at block 54, to the input signal in the first signal processing path 70 by way of the delay module 24. The delay module 24 is configured to delay the input signal in the first signal processing path by the correct number of samples equal to the processing delay in the compensation or second signal processing path, in order to equalise the time delay 24.1 through the two paths before the addition occurs.

In the second signal processing path 80, the method 60 comprises scaling, at block 56, the input signal by filtering the input signal with the Amplitude and Phase Adjustment filter 30. After filtering, the fundamental component of the filtered signal has approximately the same amplitude and phase as the undesired intermodulation signal.

The real-valued filter output is then converted, at block 58 by the quadrature generation module 32, into a complex-valued signal by the module 32 creating or generating a quadrature channel, for example, using a Hilbert filter. This avoids creation of undesired spurious components during the mixing step that follows.

If, at block 60, the negative frequency image of the input signal is desired, in other words k=−1 within the intermodulation frequency relationship ωₛ=kω+ω_{offset}, then the module 32 is configured, at block 61, to determine a conjugate of the complex-valued signal.

The method 50 then comprises translating the signal in frequency by the desired frequency offset ω_{offset}. This occurs at block 62 by way of the multiplier 34, through time-domain multiplication of the signal with a complex exponential signal with unitary amplitude and frequency ω_{offset}.

The method 50 then comprises converting, at block 64, the translated signal back to a real-valued format via the module 36. The generated signal is now in correct form and approximately equal to the undesired spurious component to be cancelled.

Though not illustrated, for completeness, it will be appreciated that the signal synthesized in the second signal processing path 80 is subtracted from the main signal in the first path 70 by way of the summing module 26, causing the undesired spurious component to approximately cancel. In this way, the method and system in accordance with the invention is not susceptible to interference from other input signals, since cancellation is not based upon measurement of spurious components in real time during operation, wherein such measurements may be inaccurate if other signals are present at the frequency of an undesired spurious component, and this may result in imperfect spurious cancellation

It will be noted that adding signals from the compensation path 80 intended for pre-distortion to cancel spurious components generated at and after the DAC 16 may lead to signal amplitude growth. The maximum amplitude of the signal is hence limited by scaling with calculated gain G from a gain module 90 (see FIG. 6), calculated such that the signal amplitude cannot grow beyond the dynamic range of the DAC 16.

The compensated signal is played out by the DAC 16 at the same sampling rate as the ADC 14.

In one example embodiment, it will be noted that significant simplifications to the algorithm as described above are possible for certain spurious components, which lead to simpler implementations. For example, in order to cancel the in-band intermodulation product of the input signal with the ADC Nyquist frequency

$$( {ω}_{offset} = \frac{{F}_{s}}{2} ) ,$$

the required processing simplifies significantly, as shown in FIG. 7. Here it is not required to convert the signal to complex-valued form, since the complex exponential e^{-jω}^{_{offset}}^{t} with which the signal is multiplied reduces to cos πn for

$${ω}_{offset} = \frac{{F}_{s}}{2}$$

with discrete time t=n/Fₛ.

The system and method described herein improves the critically important SFDR performance in ADC and DAC technology, especially for wideband case. This removes the need to trade off a high converter sampling rate with reduced SFDR performance.

The present invention provides improves SFDR for systems which receive input signals with unknown input signal frequency, which unknown frequency is not under system control. This algorithm is applicable without prior knowledge of what the input frequency will be.

The method as described is not limited to receiver architectures; it is not limited to baseband implementation and does not require frequency down-conversion or sampling rate conversion. The method described herein does not degrade with interference from other signals with the undesired intermodulation signal. For example, if a second input signal overlaps with an undesired intermodulation signal, the intermodulation signal can still be removed successfully and without cancellation of the second input signal.

The method described herein addresses at the same time intermodulation products generated by both an ADC, a DAC and RF components configured in series. The system of the invention may be placed as a component within an RF signal path to remove undesired spurious signals that occur within its instantaneous bandwidth. The method not only removes spurious signals that have already been created in preceding components, but also pre-distorts the signal to cancel spurious signals that are produced in following components. This improves system-wide SFDR performance. Additionally it allows designers to use simpler or lower-cost RF circuit architectures, or lower-cost RF components, while compensating for the resulting reduced SFDR performance digitally.

It will be appreciated that the embodiment that includes an ADC and DAC may be utilized to obtain an RF signal with improved fidelity, since it takes an RF signal as input, processes this signal in real-time, and outputs the result as an RF signal again with undesired spurious components removed, without changing the characteristics of the desired signal. Instead of obtaining RF signals with reduced spurious components by utilising RF components, as is the case in some prior art disclosures, the present disclosure presents a method and system which achieves this through digital methods using real-time, streaming digital signal processing. Applying digital methods allows increased performance and adaptability over RF methods, since it (a) allows higher accuracy in spurious cancellation processing, (b) allows cancellation of multiple spurious components simultaneously without duplicating hardware or increasing hardware complexity, and (c) allows diverse input signal types, including concurrent time-overlapping signals of which the frequency need not be known.

1. A method for processing a signal in a signal processing system, wherein the method comprises:
receiving a signal of unknown and arbitrary frequency within the operating frequency range of the signal processing system, wherein the received signal comprises a fundamental signal;
simultaneously digitally processing the received signal in at least two parallel signal processing paths, a first signal processing path and a second signal processing path, respectively;
generating, in the second signal processing path, a compensation signal by filtering the received signal with a non-adaptive time-invariant phase and amplitude adjustment filter associated with a characterised spurious signal generated in the signal processing system in processing a signal, and processing the filtered signal to correspond substantially to the frequency of the spurious signal, wherein the compensation signal is a replica of the spurious signal; and
subtracting the generated compensation signal from the received signal, or adding the generated compensation signal out of phase to the received signal, in the first signal processing path so as to cancel the spurious signal generated in the processing system thereby yielding a compensated signal.

2. A method as claimed in claim 1, wherein the method further comprises a prior step of characterising spurious signals to be cancelled by:
determining a frequency relationship between the spurious signal generated by the processing of a signal by the processing system and a fundamental signal associated with the said signal processed by the processing system;
determining an amplitude and phase relationship between the spurious signal and the fundamental signal;
generating the non-adaptive time-invariant phase and amplitude adjustment filter in the form of a wideband FIR (Finite Impulse Response) filter by using the determined amplitude and phase relationship, wherein filtering a received signal with the generated phase and amplitude adjustment filter scales same to approximately the same amplitude and phase as the spurious signal.

3. A method as claimed in claim 2, wherein the method further comprises:
generating the compensation signal by:
filtering the received signal in the second signal processing path using the generated phase and amplitude adjustment filter; and
processing the filtered signal with information indicative of the determined frequency relationship between the spurious signal and the fundamental signal such that the processed signal corresponds substantially to the frequency of the spurious signal.

4. A method as claimed in claim 3, wherein the method further comprises filtering the received signal in the second signal processing path with the phase and adjustment filter to generate a real-valued filtered signal of substantially the same amplitude and phase as the spurious signal.

5. A method as claimed in claim 3, wherein processing the filtered signal with information indicative of the determined frequency relationship between the spurious signal and the fundamental signal comprises:
converting the filtered signal to a complex-valued signal;
if a negative frequency image of the filtered signal is required, then obtaining a conjugate of the complex-valued signal;
multiplying, in the time-domain, the complex-valued signal with a complex exponential signal with unitary amplitude and a predetermined offset frequency associated with the spurious signal; and
converting the product of the multiplication step to a real-valued format, wherein the processed signal in the real-valued format is used as the compensation signal for the subtracting/adding step.

6. A method as claimed in claim 1, wherein the signal in the first processing path is delayed by a delay equivalent to a processing delay in the second signal processing path.

7. A method as claimed in claim 1, wherein the method comprises receiving the signal from an ADC (Analogue to Digital Converter), or streaming the signal from a memory device.

8. A method as claimed in claim 1, wherein the method comprises pre-distorting an output to a DAC (Digital to Analogue Converter), memory device, or processor with the compensation signal.

9. A method as claimed in claim 2, wherein determining a frequency relationship between the spurious signal and a fundamental signal of a signal processed by or in the processing system comprises:
applying a continuous wave as an input signal to the processing system;
measuring a resultant signal at a predetermined point in the processing system after generation of the spurious signal; and
measuring or determining a mathematical relationship between the frequency of the spurious signal and the frequency of the fundamental signal.

10. A method as claimed in claim 2, wherein determining an amplitude and phase relationship between the at least one spurious signal and the fundamental signal comprises;
applying a continuous wave as an input signal to the processing system for a range of distinct frequencies;
at a predetermined point in the processing system after generation of the spurious signal, determining a ratio between complex amplitudes of the spurious signal and fundamental signal from measurements taken at the predetermined point;
correcting the complex amplitude ratio, for a measured or previously determined measurement error, by a distortion factor in the processing system; and
designing or generating a FIR (Finite Impulse Response) phase and amplitude adjustment filter to approximate the amplitude and phase response of the corrected complex amplitude ratio.

11. A method as claimed in claim 1, wherein after cancelling the spurious signal, the method comprises scaling the compensated signal by applying a gain.

12. A method as claimed in claim 1, wherein the method comprises generating a compensation signal to cancel a plurality of spurious signals from the input signal.

13. A system for processing a signal in a signal processing system, wherein the system comprises:
a processor comprising:
a receiver module operable to receive a signal of unknown and arbitrary frequency within the operating frequency range of the signal processing system, wherein the received signal comprises a fundamental signal, and wherein the processor is configured to simultaneously digitally process the received signal in at least two parallel signal processing paths, a first signal processing path and a second signal processing path, respectively;
a spurious signal synthesis module located in the second signal processing path, wherein the spurious signal synthesis module is configured to generate a compensation signal by filtering the received signal with a non-adaptive time-invariant phase and amplitude adjustment filter associated with a characterised spurious signal generated in the signal processing system in processing a signal, and processing the filtered signal to correspond substantially to the frequency of the spurious signal, wherein the compensation signal is a replica of the spurious signal; and
a summing module operable to subtract the generated compensation signal from the received signal, or add the generated compensation signal out of phase to the received signal, in the first signal processing path so as to cancel the spurious signal generated in the signal processing system thereby yielding a compensated signal.

14. A system as claimed in claim 13, wherein the input received by the receiver module is received from an ADC (Analogue to Digital Converter) operatively coupled to the receiver module for sampling RF (Radio Frequency) signals, or read from a memory device.

15. A system as claimed in claim 13, wherein the system is operable to output the compensated signal to a DAC (Digital to Analogue Converter), memory device, or processor.

16. A system as claimed in claim 13, wherein the spurious signal synthesis module comprises the non-adaptive time-invariant phase and amplitude adjustment 30 filter in the form of a wideband FIR (Finite Impulse Response) filter comprising parameters based on prior spurious signal characterisation of the signal processing system.

17. A system as claimed in claim 16, wherein the spurious signal synthesis module further comprises:
a quadrature generation module to convert the filtered signal to a complex-valued signal, wherein if a negative frequency image of the filtered signal is required, then the spurious signal synthesis is configured to obtain a conjugate of the complex-valued signal;
a multiplier operable to multiply, in the time-domain, the complex-valued signal with a complex exponential signal with unitary amplitude and a predetermined offset frequency associated with the spurious signal; and
a real-value converter adapted to convert the product of the multiplier to a real-valued format compensation signal.

18. A system as claimed in claim 13, wherein the processor comprises a delay module configured to apply a delay to the received signal in the first processing path, wherein the delay is selected to be equivalent to a processing delay in the second signal processing path.

19. A system as claimed in claim 13, wherein the system comprises a memory device.

20. A system as claimed in claim 13, wherein the processor comprises a gain module operable to scale the compensated signal by applying a gain after cancelling the spurious signal.
